(19) United States
(12) Patent Application Publication
(10) Pub. No.: US 2005/0057877 A1
(43) Pub. Date: Mar. 17, 2005

(54) Over-current protection device

(76) Inventors: David Shau-Chew Wang, Taipei (TW); Yi-Nuo Chen, Taipei (TW); Chih-Ming Yu, Kaohsiung City (TW)

Correspondence Address: Harold V. Stotland;Seyfarth Shaw, 42nd Floor, 55 East Monroe Street, Chicago, IL, 60603-5803, US

(21) Appl. No.: 10/936,347

(22) Filed: Sep. 8, 2004

(30) Foreign Application Priority Data
Sep. 17, 2003 (TW) 092216659

(51) Int. Cl. H02H 5/04

(52) U.S. Cl. 361/103

(57) ABSTRACT

An over-current protection device has the characteristic of resistance tripping at least two times. Regarding the aspect of assembly, the over-current protection device is a laminate including a layer of PTC conductive material, an upper electrode foil and a lower electrode foil. As to the aspect of three-dimensional structure, the over-current protection device comprises a laminate and a first protrusion sticking out of the laminate, and the first protrusion forms an open empty room sunk in the laminate. By controlling the geometry and dimensions of the first protrusion, the relation between temperature and resistance of the over-current protection device can be adjusted.

### BACKGROUND OF THE INVENTION

(A) Field of the Invention The present invention is related to an over-current protection device, more specifically, to an over-current protection device comprising positive temperature coefficient (PTC) conductive material.

(B) Description of Related Art

For the present broad application field of portable electronic products, such as mobile phone, notebook computer, digital camera, personal digital assistant (PDA), etc., the use of over-current protection devices to prevent the short circuit caused by an over-current or over-heating effect in a secondary battery or circuit device is becoming more and more important.

FIG. 1 illustrates the relation between temperature and resistance of a known PTC conductive material. The PTC conductive material is sensitive to temperature variation, and is usually kept an extremely low resistance at normal operation due to its low sensitivity to temperature variation so that the circuit can operate normally. However, if an over-current or an over-temperature event occurs, the resistance will immediately increase to a high resistance state (e.g., above 10⁴ ohm.) Therefore, the over-current will be reversely eliminated and the objective of protecting the circuit device can be achieved. Consequently, PTC devices are applied to various circuit devices to avoid current damage.

The relation between resistance and temperature of a PTC device is dominated by the material itself, e.g., compositions of carbon blacks, polymer and fillers. To change the relation between resistance and temperature of a PTC device, it relies on changing ingredients or the percentages thereof. Accordingly, the relevant process is rather complicated and multifarious, and sometimes limited by the physical and chemical characteristics of material itself, making it difficult to achieve the requirements.

### SUMMARY OF THE INVENTION

By virtue of changing the three-dimensional geometry and dimensions, an over-current protection device can trip secondly as temperature rises so as to meet specific requirements. Further, the over-current protection device can function as a safety valve also. When the interior pressure of an apparatus employing the over-current device is too high, weaker position of the over-current device may crack into a channel for releasing the pressure.

Accordingly, the over-current protection device of the present invention has the characteristic of resistance tripping at least two times. As to the aspect of assembly, the over-current protection device includes a layer of PTC conductive material, an upper electrode foil and a lower electrode foil. As to the aspect of three-dimensional structure, the over-current protection device comprises a laminate and a first protrusion sticking out of the laminate. The first protrusion comprises an outer protruding shell with a sandwich structure of foil, PTC and foil materials, and forms an inner open empty space sunk in the laminate. By controlling the geometry and dimensions of the first protrusion, the relation between resistance and temperature of the over-current protection device can be adjusted to meet various electrical requirements.

The over-current protection device can be simply manufactured by punching so that the multiple tripping characteristic of the over current-protection device could be obtained.

### BRIEF DESCRIPTION OF THE DRAWINGS

The present invention will be described according to the appended drawings in which:

FIG. 1 illustrates the relation between temperature and resistance of a known PTC device;

FIG. 2(a) illustrates a raw material of the over-current protection device in accordance with the present invention;

FIG. 2(b) illustrates the three-dimensional diagram of the over-current protection device of the first embodiment in accordance with the present invention;

FIG. 2(c) is the cross-sectional view of line 1-1 in FIG. 2(b);

FIG. 3 illustrates the relation of temperature and resistance of the over-current protection device of the first embodiment in accordance with the present invention;

FIG. 4 illustrates the three-dimensional diagram of the over-current protection device of the second embodiment in accordance with the present invention;

FIG. 5 illustrates the three-dimensional diagram of the over-current protection device of the third embodiment in accordance with the present invention; and

FIG. 6 illustrates the three-dimensional diagram of the over-current protection device of the fourth embodiment in accordance with the present invention.

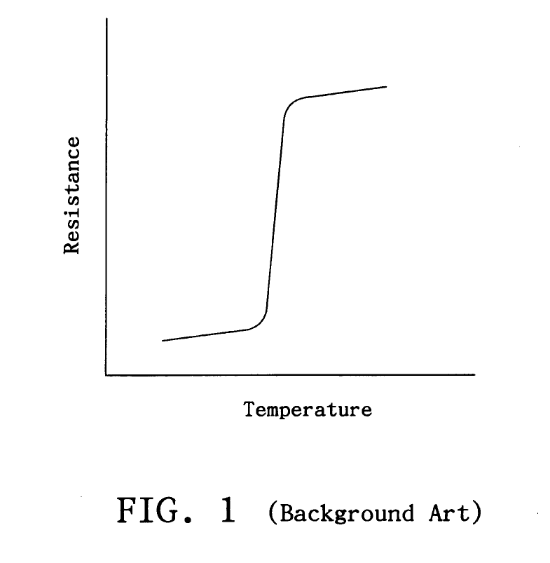

### DESCRIPTION OF PREFERRED EMBODIMENTS

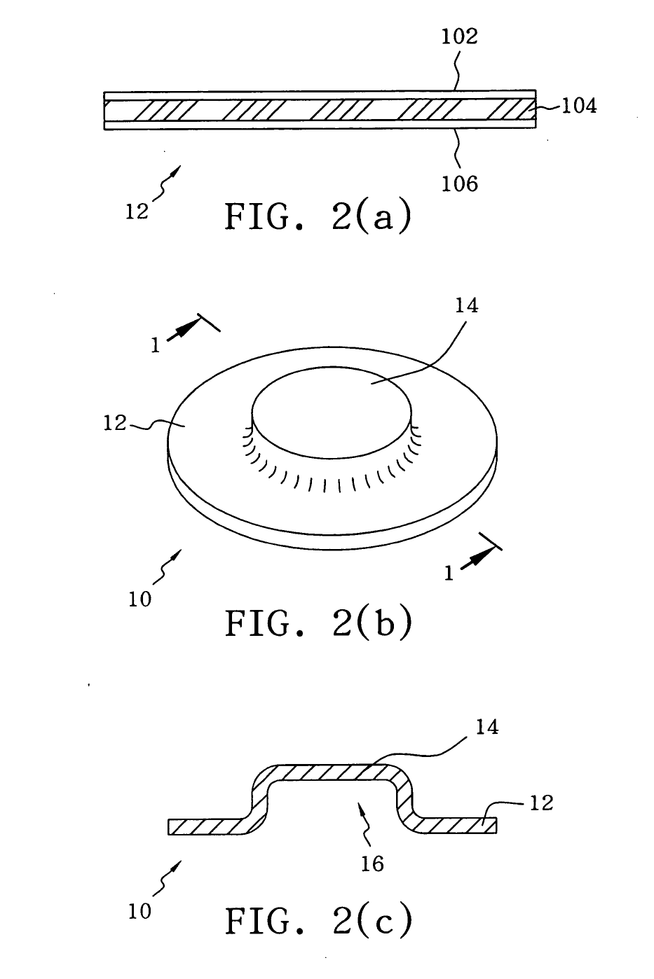

FIG. 2(a) is the side view of a PTC element shaped as a disk. The PTC element is a laminate 12 including a PTC conductive material 104, an upper electrode foil 102 and a lower electrode foil 106, wherein the upper electrode foil 102 and lower electrode foil 106 can be made of aluminum, copper, or nickel, or use copper foils electroplated nickel. Because the PTC conductive material 104, upper electrode foil 102 and lower electrode foil 106 are all extendible, the laminate 12 can be punched as an over-current protection device 10 having a central protrusion as shown in FIG. 2(b). Referring to FIG. 2(b), in the aspect of three-dimensional structure, the over-current protection device 10 comprises a laminate 12 and a first protrusion 14 sticking out of the laminate 12. The top plane of the first protrusion 14 is substantially parallel to the laminate 12, and the ratio of the height of the first protrusion 14 to the thickness of the laminate 12 is less than 30. The more preferable height to thickness ratio is from 0.5 to 20, and the most preferable height to thickness ratio is from 1 to 10. The radius of the first protrusion 14 is smaller than that of the laminate 12. FIG. 2(c) illustrates the cross-sectional view of line 1-1 in FIG. 2(b). Because the over-current protection device 10 is made by punching, the first protrusion 14 forms an open empty room 16 inside, which is sunk in the laminate 12. The sidewall of the empty room 16 may have residual stress as it is being stretched. If the over-current protection device is installed in a battery, the accompanying high temperature and high pressure when over-current occurs may induce a crack generated on the weaker position in the sidewall of the empty room 16 for pressure release. For the sake of controlling the crack position, the surface of the protrusion 14 can be marked a notch to concentrate the stress thereon. As a result, a crack can be generated along the notch even under relatively lower pressure, so that the over-current protection device 10 can function as a safety valve also.

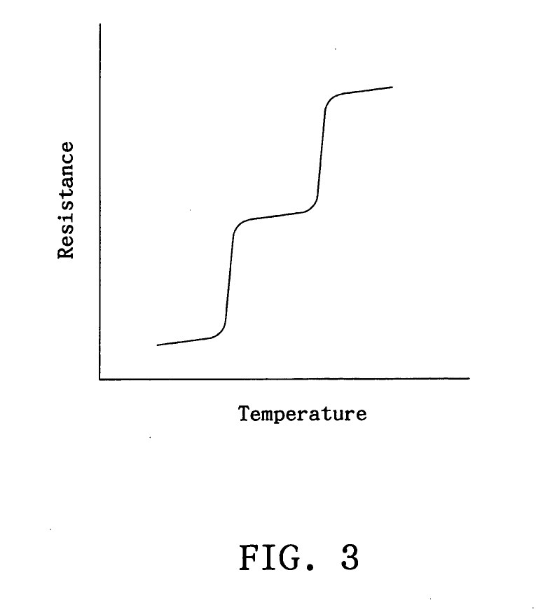

FIG. 3 illustrates the characteristic curve of resistance vs. temperature of the over-current protection device 10, in which the resistance trips twice and gradually ramps therebetween. When temperature approaches the melting point of the PTC conductive material 104, the carbon blacks needs to be separated, but will be not thoroughly separated due to the constrain of residual stress, and therefore the first resistance trip occurs. The temperature of the second resistance trip is related to the diameter of the first protrusion 14. When temperature increases to a threshold temperature, the residual stress will be released and therefore the carbon blacks within the PTC conductive material 104 will be thoroughly separated. Consequently, the second resistance trip is triggered. Because the diameter of the first protrusion 14 affects the residual stress generated during fabrication, the temperature of the second resistance trip can be controlled by adjusting the diameter of the first protrusion 14. Also, the temperature may be affected by the geometry of the over-current protection device itself. Further, the resistance of the over-current protection device when the first trip occurs is relevant to the height, i.e., the depth of punching, of the first protrusion 14. The higher the first protrusion 14 is, the lower the resistance jumping of the first trip is. In contrast, the lower the height of the first protrusion 14 is, the higher the resistance jumping of the first trip is. The over-current protection device 10 having such characteristics can be applied to some apparatuses with specific demands. For instance, the device 10 can be a temperature sensor capable of sensing two different temperatures.

The device 10 is the first embodiment of the present invention. Other embodiments applying the same skill are described as follows.

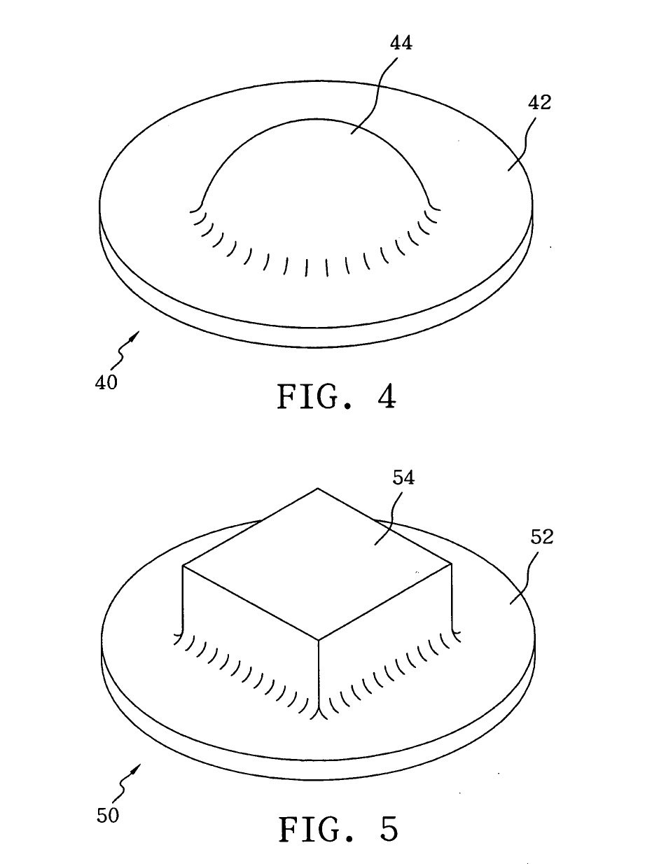

FIG. 4 illustrates the three-dimensional diagram of the over-current protection device of the second embodiment in accordance with the present invention. An over-current protection device 40 comprises a laminate 42 and a first protrusion 44 sticking out the laminate 42, where the first protrusion 44 is shaped as a semi-sphere and sticks out of the central area of the laminate 42. The first protrusion 44 has no clear top plane, so the resistance of the over-current protection device 40 may not ramp obviously after the first trip occurs.

FIG. 5 illustrates the three-dimensional diagram of the over-current protection device of the third embodiment in accordance with the present invention. An over-current protection device 50 comprises a laminate 52 and a first protrusion 54 sticking out of the first laminate 52, where the first protrusion 54 is shaped as a rectangle.

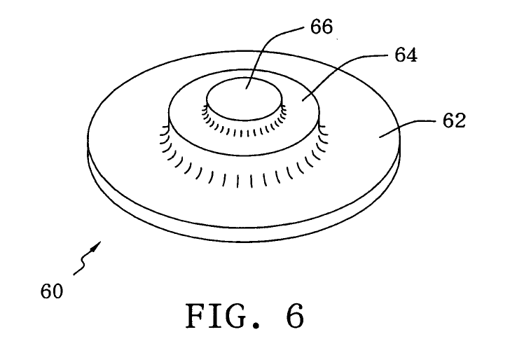

FIG. 6 illustrates the three-dimensional diagram of the over-current protection device of the fourth embodiment in accordance with the present invention, in which the over-current protection device is further added with another protrusion on the device 10 of the first embodiment. An over-current protection device 60 comprises a laminate 62, a first protrusion 64 and a second protrusion 66, where the first protrusion 64 sticks out of the laminate 62, and the second protrusion 66 sticks out of the top plane of the first protrusion 64. The over-current protection device 60 has the characteristic of three resistance trips in respect of temperature, so it can meet some specific requirements.

The above-described embodiments of the present invention are intended to be illustrative only. Numerous alternative embodiments may be devised by those skilled in the art without departing from the scope of the following claims.

1. An over-current protection device being a laminate including an upper electrode foil, a conductive material with positive temperature coefficient and a lower electrode foil, wherein a first protrusion is formed in the central area of the laminate, and an open empty room sunk in the laminate is formed beneath the first protrusion.

2. The over-current protection device of claim 1, wherein the laminate and the first protrusion are round, and the radius of the first protrusion is smaller than that of the laminate.

3. The over-current protection device of claim 1, wherein the top plane of the first protrusion is substantially parallel to the laminate.

4. The over-current protection device of claim 1, further comprising a second protrusion sticking out of the first protrusion.

5. The over-current protection device of claim 1, wherein the first protrusion is made by punching.

6. The over-current protection device of claim 1, wherein the first protrusion is shaped as a rectangle.

7. The over-current protection device of claim 1, wherein the ratio of the height of the first protrusion to the thickness of the laminate is smaller than 30.

8. The over-current protection device of claim 1, wherein the upper and lower electrode foils are selected from the group consisting of aluminum foil, copper foil, nickel foil and copper foil electroplated with nickel.

9. The over-current protection device of claim 1, wherein the surface of the first protrusion comprises at least one notch.
